(19) United States
(12) Patent Application Publication
(10) Pub. No.: US 2019/0392236 A1
(43) Pub. Date: Dec. 26, 2019

(54) USER-PROVIDED AUTOMOTIVE DATA COLLECTION

(71) Applicant: NOTTINGHAM SPIRK DESIGN ASSOCIATES, Cleveland, OH (US)

(72) Inventors: Bill NOTTINGHAM, Cleveland, OH (US); Vinit VERMA, San Francisco, CA (US); Dan MICHAEL, Cleveland, OH (US); Danwei YE, Cleveland, OH (US); John MCKENZIE, Cleveland, OH (US); Chris DEHAAS, Cleveland, OH (US); James SZPAK, Cleveland, OH (US); Vikki NOWAK, Cleveland, OH (US)

(73) Assignee: ExxonMobil Research and Engineering Company, Annandale, NJ (US)

(21) Appl. No.: 16/504,589

(22) Filed: Jul. 8, 2019

Related U.S. Application Data
(63) Continuation of application No. PCT/US19/39079, filed on Jun. 25, 2019.
(60) Provisional application No. 62/689,793, filed on Jun. 25, 2018.

(51) Int. Cl. G06K 9/00; G08B 21/06; H04N 5/225; H04N 5/247

(52) U.S. Cl. CPC G06K 9/00845; G08B 21/06; G06Q 30/0639; H04N 5/247; H04N 5/2253

(57) ABSTRACT

A system for user-provided automotive data collection includes a receiver configured to receive signals from respective electronics in respective automotive vehicles in a geographical area, the signals indicating respective amounts of fuel or respective amounts of fuel relative to capacity in the respective automotive vehicles' tanks, and a processor configured to aggregate the respective amounts of fuel to approximate a total amount of fuel relative to capacity for the geographical area, and to allocate fuel distribution to gas stations in the geographical area based on the total amount of fuel relative to capacity for the geographical area.

### BACKGROUND

Vehicle filling stations maintain stored stocks of fuel, generally in underground storage tanks, for sale to customers. In the operation of a filling station these fuel stocks are depleted by sales to customers, so that the storage tanks must be restocked with fuel from time to time by a fuel delivery. Generally, these fuel deliveries are carried out by road tanker vehicles.

The fuel is typically supplied, stored and sold in different forms, for example gasoline and diesel fuel. Moreover, both gasoline and diesel fuel may be sold in a number of different grades having different formulations. These different types and grades of fuel are stored in separate storage tanks, command different prices, and are typically sold at different rates.

The stock of stored fuel of each type and grade at a filling station must be managed by arranging the timing and volume of the fuel deliveries so that there is always a stock of fuel of each type and grade available in the storage tanks of the filling station for sale and supply to customers. However, since the customers are independent of the filling station it may be difficult to accurately predict future sales and stocks of the various fuel types and grades, making management of the fuel tank inventory difficult.

### SUMMARY OF THE INVENTION

A problem the inventors of the present application recognized is that current approaches for fuel wholesalers to attempt to predict future demand for fuel mainly involve contract agreements with retail filling stations in which the stations agree to “lift” a certain volume of fuel. Based on volumes specified by these contract agreements, wholesale fuel suppliers transport fuel to storage terminals in corresponding geographical locations. However, actual retail filling stations lift rarely aligns with contractual volume commitments because the stations may lift less than expected volumes or break contracts and procure fuel from other suppliers. Improperly allocated fuel supply causes several problems including mismatch between fuel distribution and actual demand (creating overages and shortages in some areas), increased cost of reallocating fuel, and fuel stagnation over time.

The present disclosure provides systems and methods that utilize end-user (i.e., driver) generated data to provide better insight into the fuel supply chain and more accurately predict future demand. According to various embodiments, the systems and methods of the present disclosure are capable of working independently of on-board diagnostics (OBD), telematics and the like to determine fuel levels in vehicles (and their GPS location) in near real-time. This allows the systems and methods to be readily used with vehicles manufactured by any original equipment manufacturer (OEM) such as vehicles of any make, model, and year, without any adaptation to the specific vehicle, physical interface or hardwiring. The systems and methods disclosed herein may help reduce waste and improve efficiency in fuel supply. The invention(s) disclosed here may provide these and other advantages over previously existing approaches to refueling.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a schematic view of a prior art approach to fuel distribution.

FIG. 2 illustrates a schematic diagram of a typical fuel distribution system.

FIG. 3 illustrates a schematic diagram of a system for user-provided automotive data collection.

FIG. 4 illustrates a schematic diagram of a system for obtaining from consumers automotive-related data including information about their specific fuel tank and for aggregating that data.

FIGS. 5A and 5B illustrate perspective views of an exemplary automotive-installed device.

FIG. 6 illustrates a schematic diagram of the two main pieces of the exemplary system of FIG. 4.

FIG. 7A-7C illustrate an exemplary automotive-installed device 14 in situ mounted to the steering column of a vehicle.

FIG. 8 illustrates field of vision of a front-facing camera.

FIG. 9 illustrates an exemplary screen shot of captured data visualization of the system of FIG. 4.

FIG. 10 illustrates another exemplary screen shot of captured data visualization of the system of FIG. 4.

FIG. 11 illustrates an exemplary field of view of a rear-facing camera.

FIG. 12 illustrates a flow diagram for an exemplary method for user-provided automotive data collection.

FIG. 13 illustrates a flow diagram for an exemplary method for predictably determining fuel allocation to geographical areas.

FIG. 14 illustrates a block diagram of an exemplary machine for user-provided automotive data collection and predictably determining fuel allocation to geographical areas.

### DETAILED DESCRIPTION

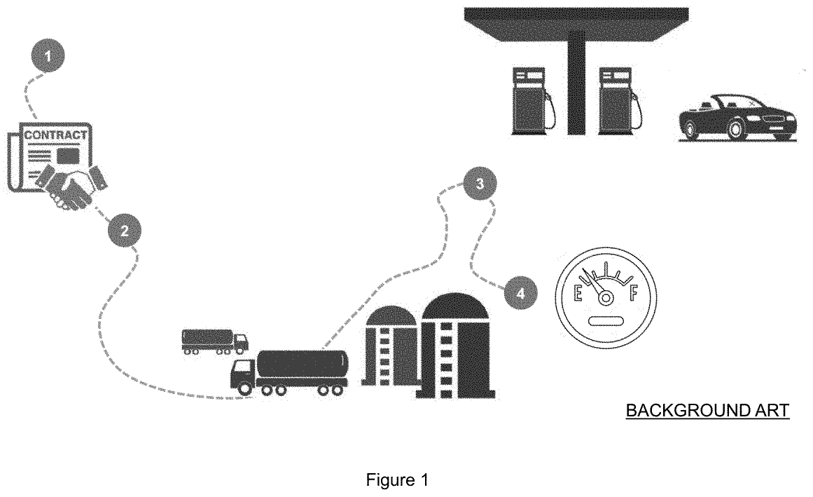

FIG. 1, which is provided merely as background for this application, illustrates a schematic view of a previous approach to fuel distribution. At 1, a fuel wholesaler may have a contractual agreement with a retail filling station in which the station agrees to “lift” a certain volume of fuel. At 2, based on volumes specified by the contractual agreement, the wholesale fuel supplier may transport fuel to storage terminals in geographical locations corresponding to the contracted-with retail filling stations. This way the fuel is within a relatively short delivery distance from the retailer and demand may be satisfied expediently. However, at 3, actual retail filling stations' lift rarely aligns with contractual volume commitments because the stations may lift less than expected volumes or break contracts and procure fuel from other suppliers. Improperly allocated fuel supply causes several problems including mismatch between fuel distribution and actual demand. At 4, mismatch between fuel distribution and actual demand may result in fuel shortages (or overages) in some geographical areas. This increases cost because of, among others, the cost of reallocating fuel, fuel stagnation over time, etc.

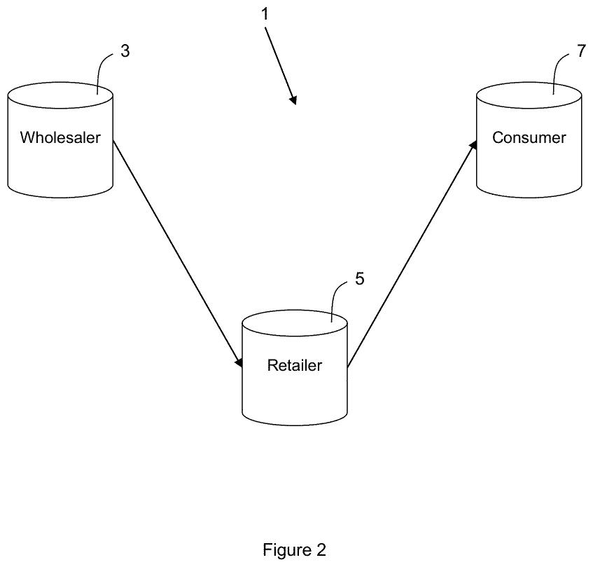

FIG. 2 illustrates a schematic diagram of a typical fuel distribution system 1. The fuel distribution system 1 may be contextualized as three tanks. The first tank 3 corresponds to the wholesaler's fuel storage facilities, which may include storage at the production facility (e.g., refinery) and wholesale distribution storage. The second tank 5 corresponds to the fuel retailer storage facilities such as the underground tanks at a filing station. The third tank 7 corresponds to all vehicles' gas tanks put together. Thus, the aggregated amount of fuel in all vehicles' gas tanks in a geographical area may be contextualized as the third tank 7.

Current technology addresses the amount fuel, rate of consumption, etc. of the first tank 3 and the second tank 5. However, current technology may not address the amount of fuel, consumption rate, etc. of the distributed tank 7 that corresponds to the aggregated tanks of all vehicles. This lack of knowledge is particularly accentuated as it relates to variances between geographical regions, time of the year, types of fuel, etc. The systems and methods disclosed herein seek to gain a handle on this third tank 7 and, since good understanding of the first 3 and second 5 tanks already exists, on the system 1 as a whole.

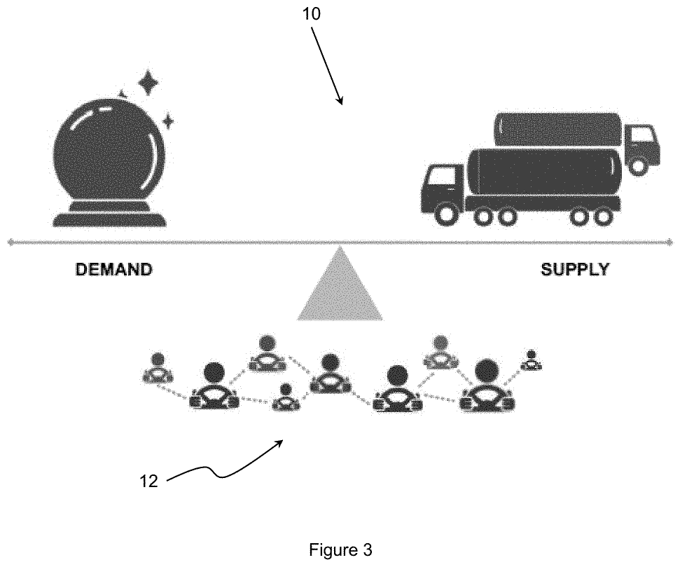

FIG. 3 illustrates a schematic diagram of a system 10 of the present disclosure. The system 10 seeks to leverage data obtained from consumers (e.g., drivers) 12 to make better predictions of fuel demand across geographical regions. Better predictions result in a better match between supply and demand, hence reducing waste and inefficiencies. In short, obtaining from consumers 12 information about their specific fuel tank and aggregating that data results in better understanding of the third tank 7, which, as described above, is the “missing piece” in understanding the fuel distribution system 1 as a whole.

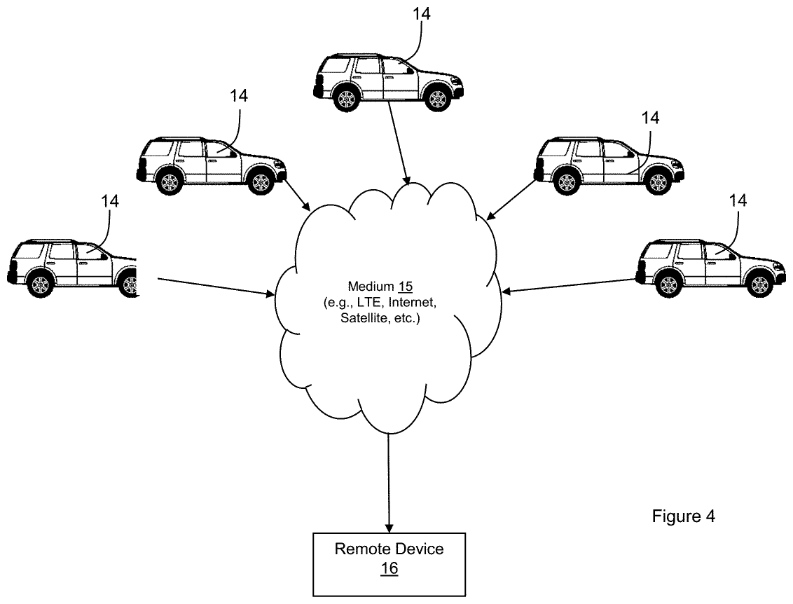

FIG. 4 illustrates a schematic diagram of such a system 10 for obtaining from consumers 12 automotive-related data including information about their specific fuel tank and for aggregating that data. The system 10 includes automotive-installed devices 14 that transmit the automotive-related data including information about their respective fuel tanks. The automotive-installed device 14 transmits the information via a medium 15 (e.g., cellular, satellite, Internet, etc.) to a remote device 16. The remote device 16 may store and aggregate data including the fuel storage information to approximate a total amount of fuel in the third tank 7.

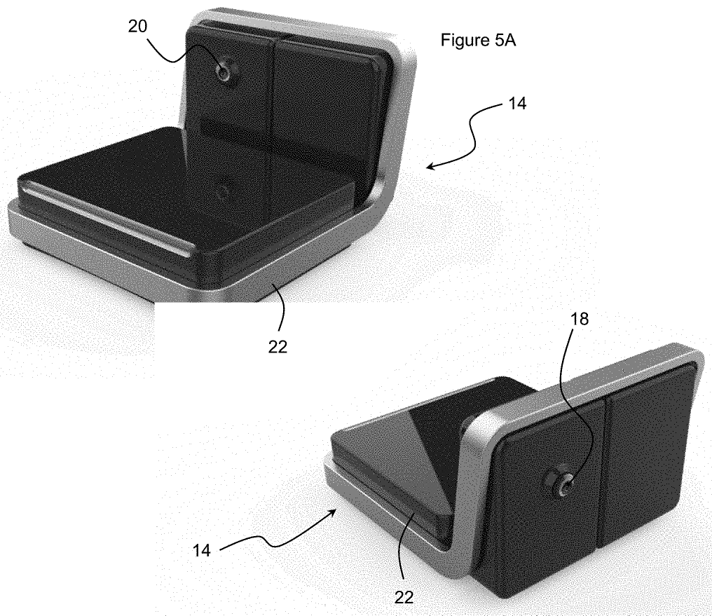

FIGS. 5A and 5B illustrate perspective views of the exemplary automotive-installed device 14. The device 14 may include a forward-facing camera 18 configured to capture images of a gauge cluster of the vehicle, as described in more detail below. The device 14 may also include a rear-facing camera 20 configured to capture images of the vehicle's driver, as described in more detail below. The device 14 may also include a housing 22, to which the front-facing 18 and rear-facing 20 cameras are operably attached. As described below, the housing 22 is also configured to mount to a portion of the vehicle's interior such as, for example, the steering column such that the front-facing camera 18 may capture images of the gauge cluster and the rear-facing camera 20 may capture images of the vehicle's driver. The automotive-installed device 14 may include, for example, a mount or attachment for attaching the device 14 to the vehicle.

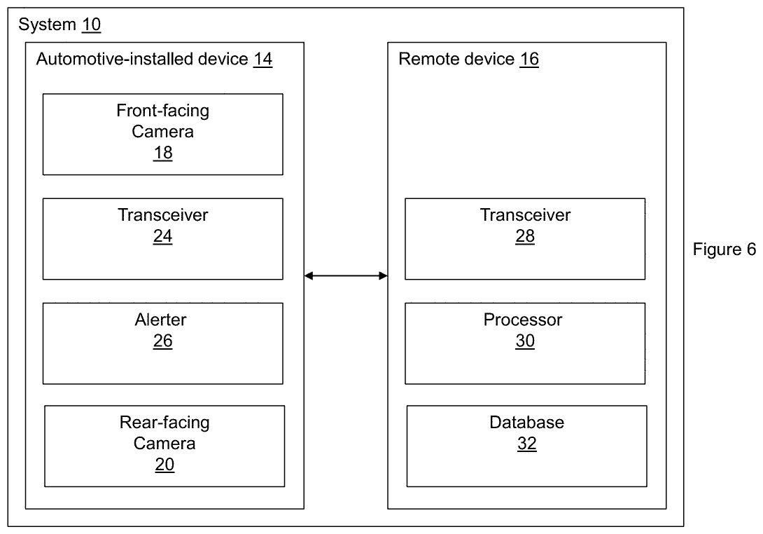

FIG. 6 illustrates a schematic diagram of the two main pieces of the exemplary system 10, the automotive-installed device 14 and the remote device 16.

The automotive-installed device 14 may include the forward-facing camera 18 configured to capture images of the gauge cluster of the vehicle. The automotive-installed device 14 may also include the rear-facing camera 20 configured to capture images of the vehicle's driver. The device 14 may also include a transceiver 24 configured to communicate with the remote device 16. The automotive-installed device 14 may also include an alerter 26.

The remote device 16 may include a transceiver 28 configured to receive data from the automotive-installed device 14 including images captured by the front-facing 18 or rear-facing 20 cameras. The remote device 16 may also include the processor 30 configured to receive the images and analyze them. These images may include captured images of the vehicle's gauge cluster. The processor 30 may receive and analyze these images of the vehicle's gauge cluster to determine a value of an automotive variable. For example, the processor 30 may receive and analyze the images of the vehicle's gauge cluster to determine an amount of fuel or a fuel tank level based on the images. Thus, the system 10 may collect data regarding the vehicle passively, without the driver's active involvement. Moreover, the system 10 may collect the automotive-variable data including fuel data independent of respective on-board diagnostics (OBD) systems of the automotive vehicles.

The processor 30 is further configured to aggregate the respective amounts of fuel to approximate a total amount of fuel relative to capacity for a geographical area. This is the information about the third fuel tank 7. Knowing this information, the system 10 may then allocate fuel distribution to fueling stations in the geographical area based on the total amount of fuel relative to capacity for that geographical area. This would help reduce waste and inefficiency.

As described in more detail below, the automotive-installed device 14 may, using the rear-facing camera 20, capture images of the driver and transmit data to the remote device via the transceiver 24. The remote device 16 may analyze the captured images and, under some conditions (e.g., the driver is falling to sleep), activate the alerter 26. So, for example, the rear-facing camera 20 may capture images of the driver and the transceiver 24 may transmit those to the remote device 16. The remote device 16 may analyze the images and detect that the driver is drowsy or falling to sleep. In such a case, the remote device 16 may activate the alerter 26 to notify the driver of the situation. In one embodiment, the automotive-installed device 14 includes within itself the processing power to analyze the images to detect the status of the driver (e.g., drowsy or sleepy) and to activate the alerter 26 to notify the driver of the status. In one embodiment, the alerter 26 includes a light (e.g., flashing red light) or an alarm.

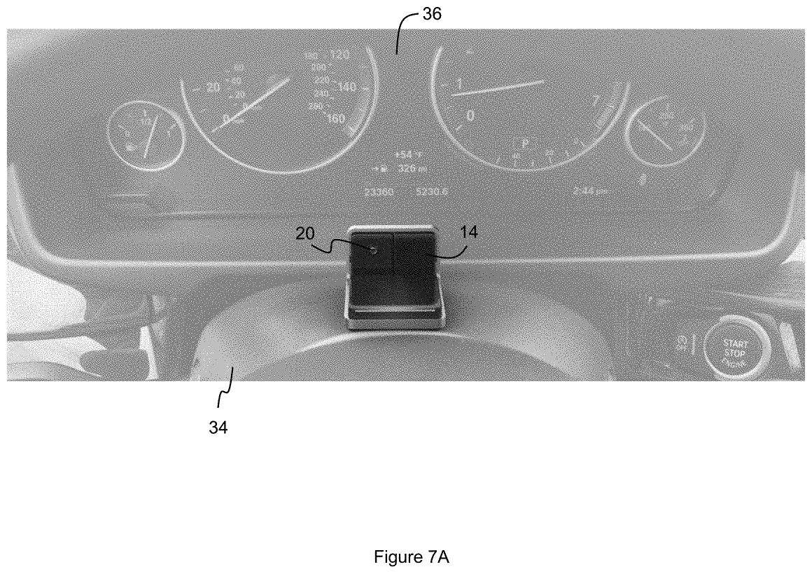

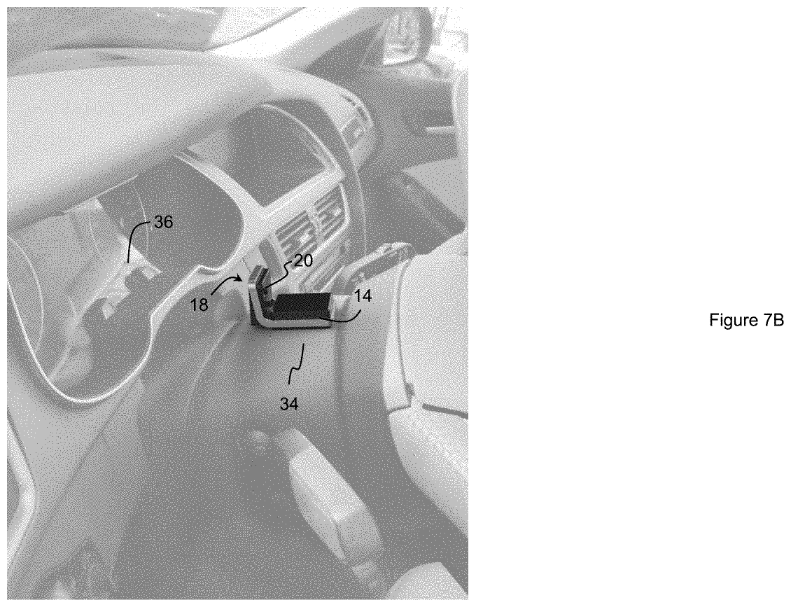

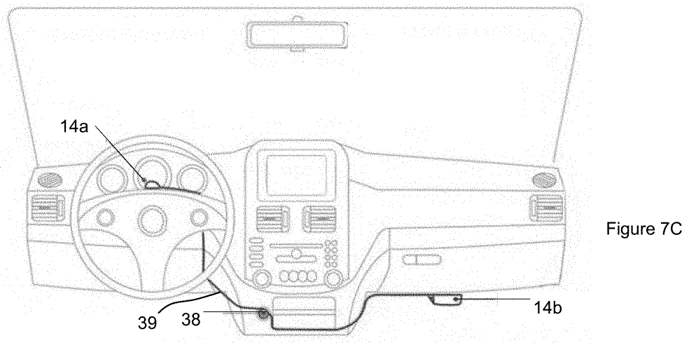

FIGS. 7A-7C illustrate the exemplary automotive-installed device 14 in situ mounted to the steering column 34 of a vehicle. As illustrated in FIGS. 7A and 7B, when the exemplary automotive-installed device 14 is mounted to the steering column 34 the front-facing camera 18 faces the gauge cluster 36 and the rear-facing camera 20 faces the driver.

As shown in FIG. 7C, the automotive-installed device 14 may receive power from a power plug 38 of the vehicle, from a USB plug of the vehicle, etc. A power harness or cable 39 may connect the device 14 to the power plug 38. In one embodiment and as illustrated in FIG. 7C, the device 14 may be distributed in portions such that a portion 14a (e.g., camera(s)) of the automotive-installed device 14 installs to the steering column 34 of the vehicle and another portion 14b may be installed at a different location (e.g., under the dash). In one embodiment, the automotive-installed device 14 is original equipment manufacturer (OEM) installed and, therefore, does not need external power, external harness, etc. as shown in FIG. 7C.

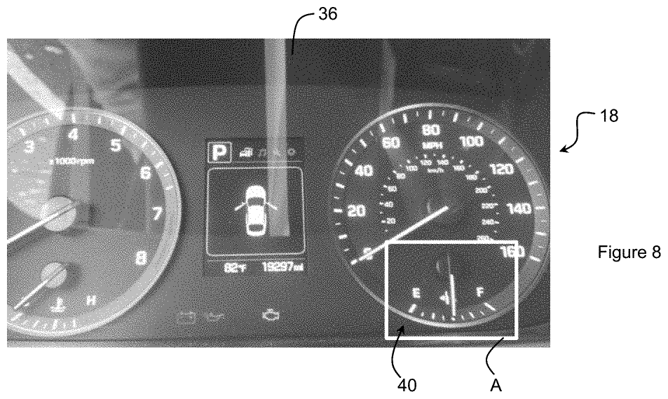

FIG. 8 illustrates field of vision of the front-facing camera 18. From the position in which it is installed, the front-facing camera 18 may capture images of the vehicle's gauge cluster 36. In the specific example of FIG. 8, the front-facing camera 18 may capture images of the fuel gauge 40 of the vehicle. As can be seen in FIG. 8, however, the front-facing camera 18 may also capture images of the vehicle's speedometer, tachometer, oil temperature gauge, odometer, battery service light, oil service light, engine service light, etc. Thus, the system 10 may capture data regarding fuel level, fuel consumption, fuel efficiency, oil level, oil life, tire pressure, vehicle mileage, oil temperature, warning indicators, mileage, etc.

The front-facing camera 18 my capture the images of the fuel gauge 40 (or other gauges or indicators) and the transceiver 24 may transmit the images to the remote device 16. The remote device's processor 30 may then analyze the captured images to extract automotive variable (e.g., fuel level) information. The processor 30 may interpret the gauges using, for example, so-called computer vision or machine vision. Some of those techniques are described in the following documents, which are hereby incorporated by reference in their entirety: “Machine Vision Based Automatic Detection Method of Indicating Values of a Pointer Gauge, Mathematical Problems in Engineering,” Volume 2015, Article ID 283629, 19 pages, http://dx.doi.org/10.1155/2015/283629, “Automatic interpretation of analog dials in driver's instrumentation panel,” 2017 Third International Conference on Advances in Electrical, Electronics, Information, Communication and Bio-Informatics (AEEICB), pp. 411-415, https://doi.org/10.1109/AEEICB.2017.7972343, “A clustering-based algorithm for automatic detection of automobile dashboard,” IECON 2017—43rd Annual Conference of the IEEE Industrial Electronics Society, pp. 3259-3264, https://doi.org/10.1109/IECON.2017.8216551, “A Robust and Automatic Recognition System of Analog Instruments in Power System by Using Computer Vision,” Measurement, 2016, https://doi.org/10.1016/j.measurement.2016.06.045.

In one embodiment, the remote device 16 has access to a database 32 including images or fingerprints of gauge clusters of all or at least a large portion of all vehicles on the road. By comparing the images or fingerprints to the images captured by the front-facing camera 18 (or to fingerprints thereof), the processor 30 may identify the specific gauge cluster. Based on that information, the processor 30 may then identify an area corresponding to the gauge or indicator of interest. In the example of FIG. 8, the system 10 identifies the area A as the area corresponding to the fuel gauge 40 on the identified gauge cluster 36. Using computer vision or machine vision techniques, the processor 30 may then identify a fuel level of the vehicle. In one example, the forward-facing camera 18 captures the gauge cluster images at a time when an ignition of the vehicle is operated to turn the vehicle on or off. In one example, the forward-facing camera captures the gauge cluster images periodically when the vehicle is on.

The system may capture data regarding fuel level, fuel consumption, fuel efficiency, oil level, oil life, tire pressure, vehicle mileage, oil temperature, warning indicators, mileage, etc. In one embodiment, the automotive-installed device 14 also includes or is connected to a GPS receiver (e.g., to a mobile phone via Bluetooth). With this vast array of information available, the system 10 may be used for countless other applications in addition to fuel distribution optimization.

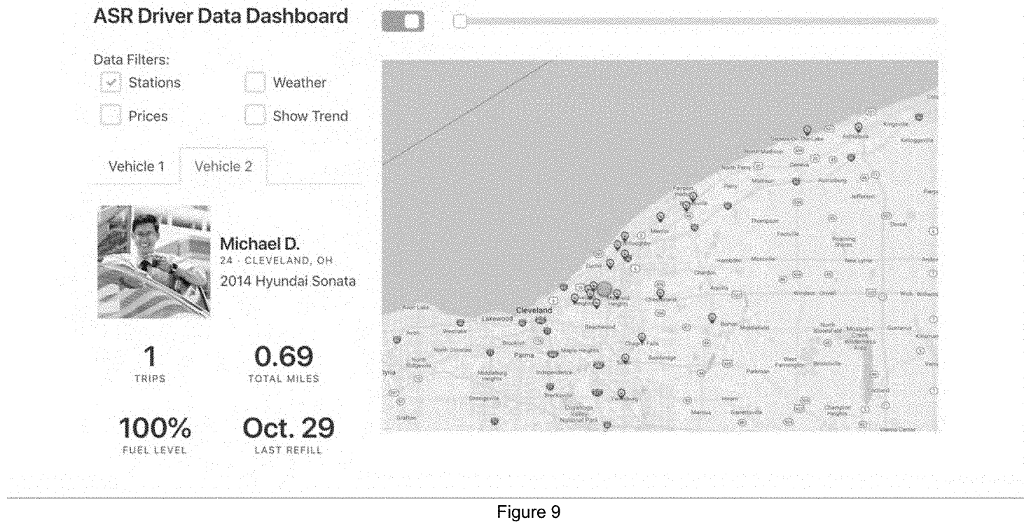

FIG. 9 illustrates an exemplary screen shot of captured data visualization of the system 10. In this example, the system 10 displays a vehicle's visited retail filling stations, number of trips post-fill up, number of miles post-fill up, current fuel level, day of last fill-up, etc. Again, with this vast array of information available, the system 10 may be used for countless applications.

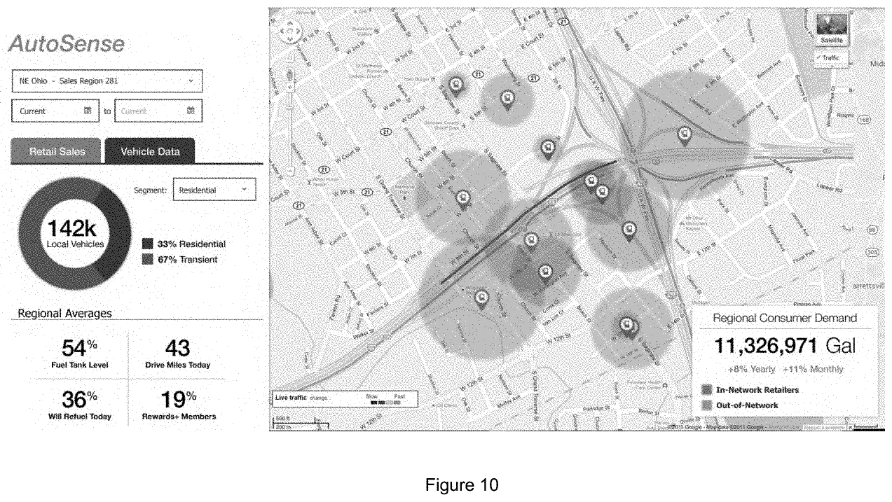

FIG. 10 illustrates another exemplary screen shot of captured data visualization of the system 10. In this example, the system 10 displays filling stations' locations and a graphical comparative representation of storage tank levels at the filling stations (i.e., bigger circles around a station represent fuller fuel storage tanks). Importantly, for the geographical area depicted in the map, the system 10 may display a total number of vehicles, an average fuel tank level, an average number of miles driven by the vehicles, and an average (e.g., daily, yearly, etc.) fuel demand for the geographical area.

As can be seen from the above, the more vehicles in a geographical area that have installed thereon the automotive-installed device 14, the more accurate the “third tank” 7 data becomes. Therefore, high user take rates is desirable. In that context, a fuel wholesaler, for example, that wishes to obtain accurate fuel data may seek to incentivize drivers to install or use the automotive-installed device 14 in their vehicles. In one embodiment, the system 10 offers driver's aids to motivate drivers to install or use the automotive-installed device 14.

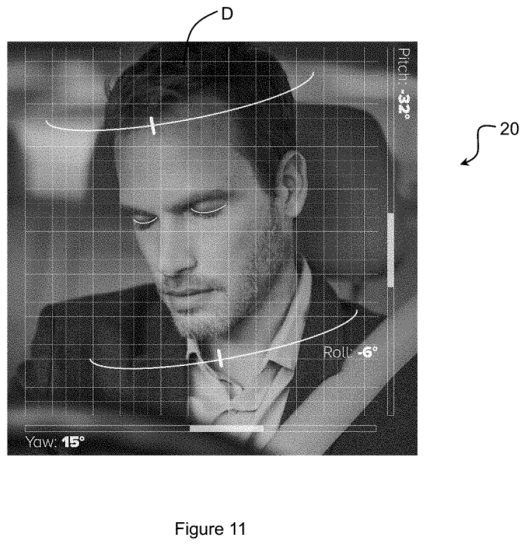

FIG. 11 illustrates an exemplary field of view of the rear-facing camera 20. The rear-facing camera 20 may capture images of the vehicle's driver D and the transceiver 24 may transmit data including the capture images to the remote device 16. The processor 30 may then use computer vision or machine vision to determine and activate an alert when the driver is drowsy, sleepy, inattentive, etc. The processor 30 may, for example, determine a pitch, roll, or yaw of the driver's head and alert whenever such determination indicates the driver D is falling to sleep. In another embodiment, the processor 30 may determine that the driver's eyes are closed and alert the driver D is falling to sleep.

The rear-facing camera 20 may be used in conjunction with the processor 30 in the remote device 16 (or a processor local to the automotive-installed device 14) to provide various different very convenient features to the vehicle's driver D. This is a quid pro quo in which the driver D may agree to install and use the automotive-installed device 14 including the front-facing camera 18 for, for example, the fuel wholesaler to capture gauge cluster data in exchange for the convenience features provided by the rear-facing camera 20.

The system 10 may be implemented using software, hardware, analog or digital techniques.

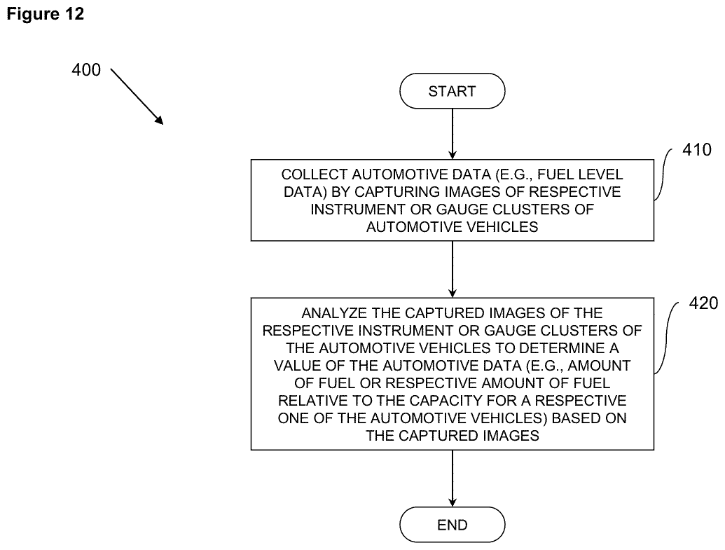

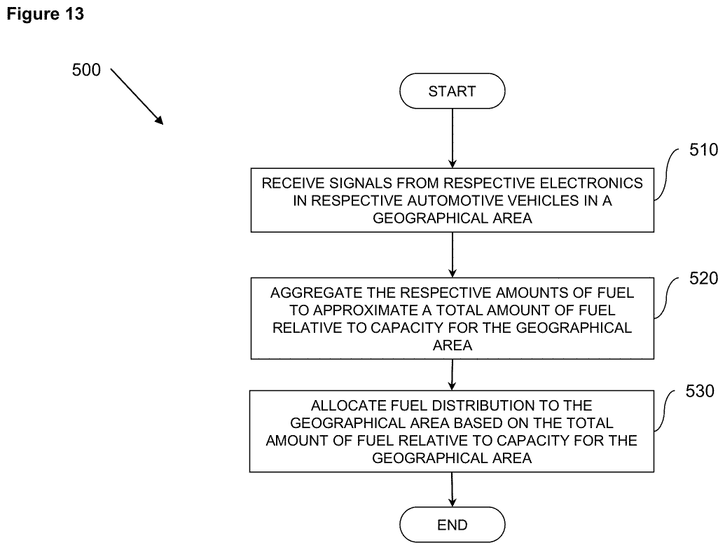

Exemplary methods may be better appreciated with reference to the flow diagrams of FIGS. 12 and 13. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

Although the figures illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed, and that lightweight processes, regular processes, threads, and other approaches could be employed. It is to be appreciated that other exemplary methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

FIG. 12 illustrates a flow diagram for an exemplary method 400 for user-provided automotive data collection. At 410, the method 400 includes collecting automotive data (e.g., fuel level data) by capturing images of respective instrument or gauge clusters of automotive vehicles. At 420, the method 400 includes analyzing the captured images of the respective instrument or gauge clusters of the automotive vehicles to determine a value of the automotive data (e.g., amount of fuel or respective amount of fuel relative to the capacity for a respective one of the automotive vehicles) based on the captured images.

FIG. 13 illustrates a flow diagram for an exemplary method 500 for predictably determining fuel allocation to geographical areas. At 510, the method 500 includes receiving signals from respective electronics in respective automotive vehicles in a geographical area, the signals indicating respective amounts of fuel or respective amounts of fuel relative to capacity in the respective automotive vehicles' tanks. At 520, the method 500 includes aggregating the respective amounts of fuel to approximate a total amount of fuel relative to capacity for the geographical area. At 530, the method 500 includes allocating fuel distribution to the geographical area based on the total amount of fuel relative to capacity for the geographical area.

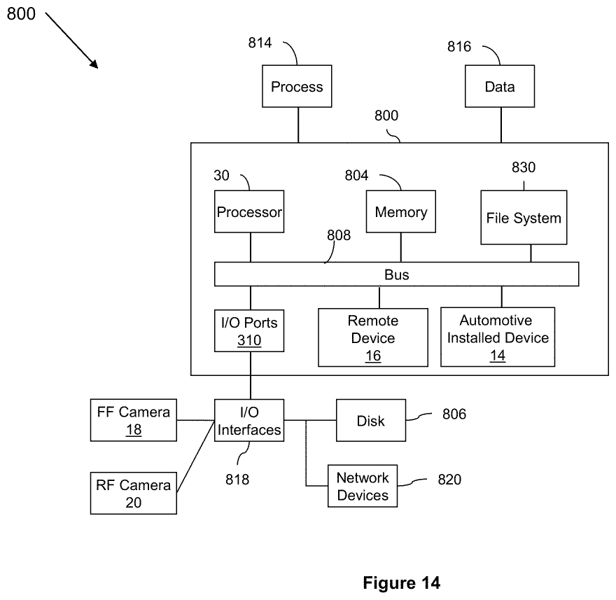

FIG. 14 illustrates a block diagram of an exemplary machine 800 for user-provided automotive data collection and predictably determining fuel allocation to geographical areas. The machine 800 includes a processor 43, a memory 804, and I/O Ports 810 operably connected by a bus 808.

In one example, the machine 800 may receive input signals including capture images via, for example, I/O Ports 810 or I/O Interfaces 818 to which the front-facing camera 18 and the rear-facing camera 20 may be connected. The machine 800 may also include the transceivers 24, 28, the processor 30, and the database 32 of the automotive-installed device 14 and the remote device 16. Thus, the automotive-installed device 14 and the remote device 16 may be implemented in machine 800 as hardware, firmware, software, or a combination thereof and, thus, the machine 800 and its components may provide means for performing functions described and/or claimed herein as performed by the automotive-installed device 14 and the remote device 16.

The processor 33 can be a variety of various processors including dual microprocessor and other multi-processor architectures. The memory 804 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the machine 800 via, for example, an I/O Interfaces (e.g., card, device) 818 and an I/O Ports 810. The disk 806 can include, but is not limited to, devices like a magnetic disk drive, a solid-state disk drive, a floppy disk drive, a tape drive, a Zip drive, a flash memory card, or a memory stick. Furthermore, the disk 806 can include optical drives like a CD-ROM, a CD recordable drive (CD-R drive), a CD rewriteable drive (CD-RW drive), or a digital video ROM drive (DVD ROM). The memory 804 can store processes 814 or data 816, for example. The disk 806 or memory 804 can store an operating system that controls and allocates resources of the machine 800.

The bus 808 can be a single internal bus interconnect architecture or other bus or mesh architectures. While a single bus is illustrated, it is to be appreciated that machine 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The machine 800 may interact with input/output devices via I/O Interfaces 818 and I/O Ports 810. Input/output devices can include, but are not limited to, a keyboard, a microphone, a pointing and selection device, cameras 18, 20, video cards, displays, disk 806, network devices 820, and the like. The I/O Ports 810 can include but are not limited to, serial ports, parallel ports, and USB ports.

The machine 800 can operate in a network environment and thus may be connected to network devices 820 via the I/O Interfaces 818, or the I/O Ports 810. Through the network devices 820, the machine 800 may interact with a network. Through the network, the machine 800 may be logically connected to remote computers. The networks with which the machine 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 820 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

As used herein, an “operable connection” or “operable coupling,” or a connection by which entities are “operably connected” or “operably coupled” is one in which the entities are connected in such a way that the entities may perform as intended. An operable connection may be a direct connection or an indirect connection in which an intermediate entity or entities cooperate or otherwise are part of the connection or are in between the operably connected entities. In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted, or detected.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A system for user-provided automotive data collection, comprising:
an automotive-installed device comprising:
a forward-facing camera configured to capture images;
a housing to which the forward-facing camera is operably attached, the housing including an attachment configured to attach the device to a portion of a vehicle's interior [such as, for example, a steering column] such that the forward-facing camera captures one or more images of the vehicle's gauge cluster; and
a transmitter configured to transmit the one or more images of the vehicle's gauge cluster;
a remote device comprising:
a receiver configured to receive the one or more images of the vehicle's gauge cluster; and
a processor configured to receive the one or more images of the vehicle's gauge cluster from the receiver and analyze the one or more images of the vehicle's gauge cluster to determine a value of an automotive variable based on the one or more images of the vehicle's gauge cluster.

2. The system of claim 1, wherein
the one or more images of the vehicle's gauge cluster indicate respective amounts of fuel or respective amounts of fuel relative to capacity in the respective vehicle's tank;
the processor is configured to aggregate the respective amounts of fuel to approximate a total amount of fuel relative to capacity for a geographical area, and to allocate fuel distribution to fueling stations in the geographical area based on the total amount of fuel relative to capacity for the geographical area.

3. The system of claim 1, wherein the transmitter wirelessly transmits the one or more images remotely from the vehicle [LTE or similar transmitter] to the receiver.

4. The system of claim 1, wherein the automotive variable includes:
fuel level,
fuel consumption,
fuel efficiency,
oil level,
oil life,
tire pressure,
vehicle mileage,
vehicle temperature, and
warning indicators.

5. The system of claim 1, the automotive-installed device comprising:
location tracking via GPS and/or location of connecting antenna(s) including triangulation methods.

6. The system of claim 1,
wherein the automotive-installed device comprises:
a rear-facing camera configured to capture images;
the housing, to which the rear-facing camera is operably attached, includes the attachment configured to attach the device to the portion of the vehicle's interior [such as, for example, the steering column] such that the rear-facing camera captures one or more images of the vehicle's driver; and
the transmitter configured to transmit the one or more images of the vehicle's driver;
wherein the remote device comprises:
the receiver configured to receive the one or more images of the vehicle's driver; and
the processor configured to receive the one or more images of the vehicle's driver from the receiver and analyze the one or more images of the vehicle's driver to determine a state of the driver.

7. The system of claim 6, wherein the state of the driver includes one or more of:
drowsy,
sleepy,
attentive.

8. The system of claims 6, wherein:
the remote device comprises:
a transmitter to transmit the data related to the state of the driver to the automotive-installed device;
the automotive-installed device comprises:
a receiver for receiving the data related to the state of the driver; and
an alerter configured to provide an audio, visual, or sensory alert based on the state of the driver [for example, to awake a driver whose state is sleepy].

9. A system for user-provided automotive data collection comprising:
a receiver configured to receive signals from respective electronics in respective automotive vehicles in a geographical area, the signals indicating respective amounts of fuel or respective amounts of fuel relative to capacity in the respective automotive vehicles' tanks;
a processor configured to aggregate the respective amounts of fuel to approximate a total amount of fuel relative to capacity for the geographical area, and to allocate fuel distribution to gas stations in the geographical area based on the total amount of fuel relative to capacity for the geographical area.

10. The system of claim 9, comprising:
an automotive-installed device configured to passively [without user involvement] collect fuel amount data at the automotive vehicles.

11. The system of claim 9, comprising:
an automotive-installed device configured to passively [without user involvement] collect fuel amount data at the automotive vehicles independent of respective on-board diagnostics (OBD) systems of the automotive vehicles.

12. The system of claim 9, comprising:
an automotive-installed device comprising:
a forward-facing camera configured to capture images;
a housing to which the forward-facing camera is operably attached, the housing including an attachment configured to attach the device to a portion of a vehicle's interior [such as, for example, a steering column] such that the forward-facing camera captures one or more images of the vehicle's gauge cluster; and
a transmitter configured to transmit the signals indicating respective amounts of fuel or respective amounts of fuel relative to the capacity in the respective automotive vehicles including the one or more images of the vehicle's gauge cluster.

13. The system of claim 9, comprising:
an automotive-installed device comprising:
a forward-facing camera configured to capture images;
a housing to which the forward-facing camera is operably attached, the housing including an attachment configured to attach the device to a portion of a vehicle's interior [such as, for example, a steering column] such that the forward-facing camera captures one or more images of the vehicle's gauge cluster; and
a transmitter configured to transmit the signals indicating respective amounts of fuel or respective amounts of fuel relative to the capacity in the respective automotive vehicles including the one or more images of the vehicle's gauge cluster.
the receiver configured to receive the signals and the processor configured to analyze the captured images of the respective instrument or gauge clusters of the automotive vehicles to determine a value of the amount of fuel or respective amount of fuel relative to the capacity for a respective one of the automotive vehicles based on the captured images.

14. The system of claim 9, wherein, in addition to indicating the respective amounts of fuel or the respective amounts of fuel relative to capacity in the respective automotive vehicles, the signals indicate respective at least one of:
a. fuel consumption,
b. fuel efficiency,
c. oil level,
d. oil life,
e. tire pressure,
f. vehicle mileage,
g. vehicle temperature, and
h. warning indicators.

15. The system of claim 9, wherein, in addition to indicating the respective amounts of fuel or the respective amounts of fuel relative to capacity in the respective automotive vehicles, the signals indicate respective locations of the automotive vehicles.

16. The system of claim 9, wherein the signals indicating respective amounts of fuel or respective amounts of fuel relative to the capacity in the respective automotive vehicles include data representing respective captured images of:
instrument or gauge clusters of the automotive vehicles, and
the automotive vehicles' drivers.

17. The system of claim 9, wherein the signals include data representing respective captured images of:
instrument or gauge clusters of the automotive vehicles, and
the automotive vehicles' drivers;
the system comprising:
analyzing the captured images of a vehicle's driver to determine a state of the driver, wherein the state of the driver includes one or more of:
drowsy,
sleepy, and
attentive.

18. The system of claim 9, wherein the signals include data representing respective captured images of:
instrument or gauge clusters of the automotive vehicles, and
the automotive vehicles' drivers;
the system comprising:
analyzing the captured images of a specific vehicle's driver to determine a state of the driver; and
transmitting data related to the state of the driver of the specific vehicle to provide an audio, visual, or sensory alert based on the state of the driver.

19. A method for user-provided automotive data collection comprising:
receiving signals from respective electronics in respective automotive vehicles in a geographical area, the signals indicating respective amounts of fuel or respective amounts of fuel relative to capacity in the respective automotive vehicles' tanks;
aggregating the respective amounts of fuel to approximate a total amount of fuel relative to capacity for the geographical area; and
allocating fuel distribution to the geographical area based on the total amount of fuel relative to capacity for the geographical area.

20. The method of claim 19, comprising:
passively [without user involvement] collecting fuel amount data at the automotive vehicles.

21. The method of claim 19, comprising:
passively [without user involvement] collecting fuel amount data at the automotive vehicles independent of respective on-board diagnostics (OBD) systems of the automotive vehicles.

22. The method of claim 19, wherein the signals indicating respective amounts of fuel or respective amounts of fuel relative to the capacity in the respective automotive vehicles include data representing captured images of respective instrument or gauge clusters of the automotive vehicles.

23. The method of claim 19, comprising:
collecting fuel amount data by capturing images of respective instrument or gauge clusters of the automotive vehicles.

24. The method of claim 19, wherein the signals indicating respective amounts of fuel or respective amounts of fuel relative to the capacity in the respective automotive vehicles include data representing captured images of respective instrument or gauge clusters of the automotive vehicles, the method comprising:
analyzing the captured images of the respective instrument or gauge clusters of the automotive vehicles to determine a value of the amount of fuel or respective amount of fuel relative to the capacity for a respective one of the automotive vehicles based on the captured images.

25. The method of claim 19, wherein
the signals indicating respective amounts of fuel or respective amounts of fuel relative to the capacity in the respective automotive vehicles include data representing captured images of respective instrument or gauge clusters of the automotive vehicles, and
the receiving the signals includes receiving signals transmitted wirelessly via a wireless transmitter of a device that captures the captured images or via a wireless transmitter of a mobile phone transmittably connected to the device that captures the captured images.

26. The method of claim 19, wherein, in addition to indicating the respective amounts of fuel or the respective amounts of fuel relative to capacity in the respective automotive vehicles, the signals indicate respective at least one of:
i. fuel consumption,
j. fuel efficiency,
k. oil level,
l. oil life,
m. tire pressure,
n. vehicle mileage,
o. vehicle temperature, and
p. warning indicators.

27. The system of claim 19, wherein, in addition to indicating the respective amounts of fuel or the respective amounts of fuel relative to capacity in the respective automotive vehicles, the signals indicate respective locations of the automotive vehicles.

28. The method of claim 19, wherein the signals indicating respective amounts of fuel or respective amounts of fuel relative to the capacity in the respective automotive vehicles include data representing respective captured images of:
instrument or gauge clusters of the automotive vehicles, and
the automotive vehicles' drivers.

29. The method of claim 19, wherein the signals include data representing respective captured images of:
instrument or gauge clusters of the automotive vehicles, and
the automotive vehicles' drivers;
the method comprising:
analyzing the captured images of a vehicle's driver to determine a state of the driver, wherein the state of the driver includes one or more of:
drowsy,
sleepy, and
attentive.

30. The method of claim 19, wherein the signals include data representing respective captured images of:
instrument or gauge clusters of the automotive vehicles, and
the automotive vehicles' drivers;
the method comprising:
analyzing the captured images of a specific vehicle's driver to determine a state of the driver; and
transmitting data related to the state of the driver of the specific vehicle to provide an audio, visual, or sensory alert based on the state of the driver.
